(19) United States
(12) Patent Application Publication
(10) Pub. No.: US 2007/0174140 A1
(43) Pub. Date: Jul. 26, 2007

(54) Electronic Sell-Through Of Multimedia Content Through Points-Of-Sale

(75) Inventors: James F. Noonan, Monte Nido, CA (US); Khalid R. Oreif, La Canada, CA (US)

Correspondence Address: WALTER W. DUFT;LAW OFFICES OF WALTER W. DUFT, 8616 MAIN ST, SUITE 2, WILLIAMSVILLE, NY, 14221, US

(73) Assignee: WARNER BROS. ENTERTAINMENT, INC., Burbank, CA (US)

(21) Appl. No.: 11/560,207

(22) Filed: Nov. 15, 2006

Related U.S. Application Data
(60) Provisional application No. 60/737,056, filed on Nov. 15, 2005.

(51) Int. Cl. G06Q 30/00

(52) U.S. Cl. 705/27

(57) ABSTRACT

A point-of-sale system for electronic sell-through of multimedia content comprises a kiosk for customer selection and transfer of multimedia content to a customer device. The kiosk may include a local multimedia library containing multimedia content in machine-readable form, a customer communication interface adapted to facilitate electronic communication between the kiosk and a customer device, and customer transaction logic adapted to facilitate customer selection and transfer of multimedia content in the multimedia library to the customer device via the communication interface. A main server may be provided that communicates with the kiosk and other kiosks of like kind in order to oversee kiosk operations and update the local multimedia libraries.

### CROSS-REFERENCE TO RELATED APPLICATION

This application claims the benefit U.S. Provisional Application Ser. No. 60/737,056, filed on Nov. 15, 2005.

### BACKGROUND OF THE INVENTION

1. Field of the Invention

The present invention relates to the distribution of video, audio, software and other multimedia content for consumer acquisition and consumption.

2. Description of Prior Art

By way of background, multimedia materials, such as movies, television programs, videos, music, games and other assets, have been distributed through a variety of channels for fee-based acquisition (e.g., purchase, rental, subscription, pay-per-view, etc.) by consumers. For example, movies and television programs are typically available via cable or satellite television transmission, downloading over the Internet, and through retail sale and rental outlets. Other works such as music and games are generally distributed via the Internet and through retail channels.

For consumers wishing to access multimedia materials via portable devices, such as laptop computers, handheld media storage-playback devices, miniature gaming machines, cellular telephones, etc., the available choices for acquiring and installing new multimedia content on the machine tend to be limited to downloading over the Internet or obtaining prerecorded media. A disadvantage of Internet downloading is that the download time can be extremely long, especially for motion pictures. For example, a DVD-formatted movie requires several gigabytes of storage space and can take upwards of an hour to download at T1 speed (1.5 Mbps). For a dial-up connection, the download time is many hours. A disadvantage of using prerecorded media is that the media must be physically acquired via mail order or by visiting a retail outlet.

There are many instances where consumers who do not have time for Internet downloading and who lack access to a retail outlet may nonetheless desire to install new multimedia content on a computer or other device. For example, a person at an airport waiting to board a flight might wish to obtain a movie to watch during their trip. Alternatively, a subway commuter might want to download a game to play on the ride home.

Accordingly, it is to improvements in the distribution of multimedia materials that the present invention is directed. What is particularly needed is an improved technique that allows multimedia content to be acquired and installed on a portable device, particularly when other means of acquisition are not feasible or available.

### SUMMARY OF THE INVENTION

The foregoing problems are solved and an advance in the art is achieved by a novel point-of-sale system for electronic sell-through of multimedia content. In one aspect, the system comprises a kiosk for customer selection and transfer of multimedia content to a customer device. The kiosk may include a local multimedia library containing multimedia content in machine-readable form, a customer communication interface adapted to facilitate electronic communication between the kiosk and the customer device, and customer transaction logic adapted to facilitate customer selection and transfer of multimedia content from the multimedia library to the customer device via the communication interface. In another aspect, a main server is provided that communicates with the kiosk and with other kiosks of like kind in order to oversee kiosk operations and update the local multimedia libraries.

### BRIEF DESCRIPTION OF THE DRAWINGS

The foregoing and other features and advantages of the invention will be apparent from the following more particular description of an exemplary embodiment of the invention, as illustrated in the accompanying Drawings in which:

FIG. 1 is a functional block diagram showing an exemplary point-of-sale system for electronic sell-through of multimedia content;

FIG. 2 is a functional block diagram showing exemplary components a kiosk of the point-of-sale system of FIG. 1;

FIG. 3 is a functional block diagram showing exemplary menu-supported customer transaction functions provided by the kiosk of FIG. 2;

FIG. 4 is a functional block diagram showing exemplary components a main server farm of the point-of-sale system of FIG. 1;

FIG. 5 is a flow diagram showing exemplary operations of the kiosk of FIG. 2;

FIGS. 6 is a flow diagram showing exemplary interactions between the kiosk of FIG. 2 and the server farm of FIG. 4; and

FIG. 7 is a flow diagram showing exemplary operations of the server farm of FIG. 4.

### DETAILED DESCRIPTION OF EXEMPLARY EMBODIMENT

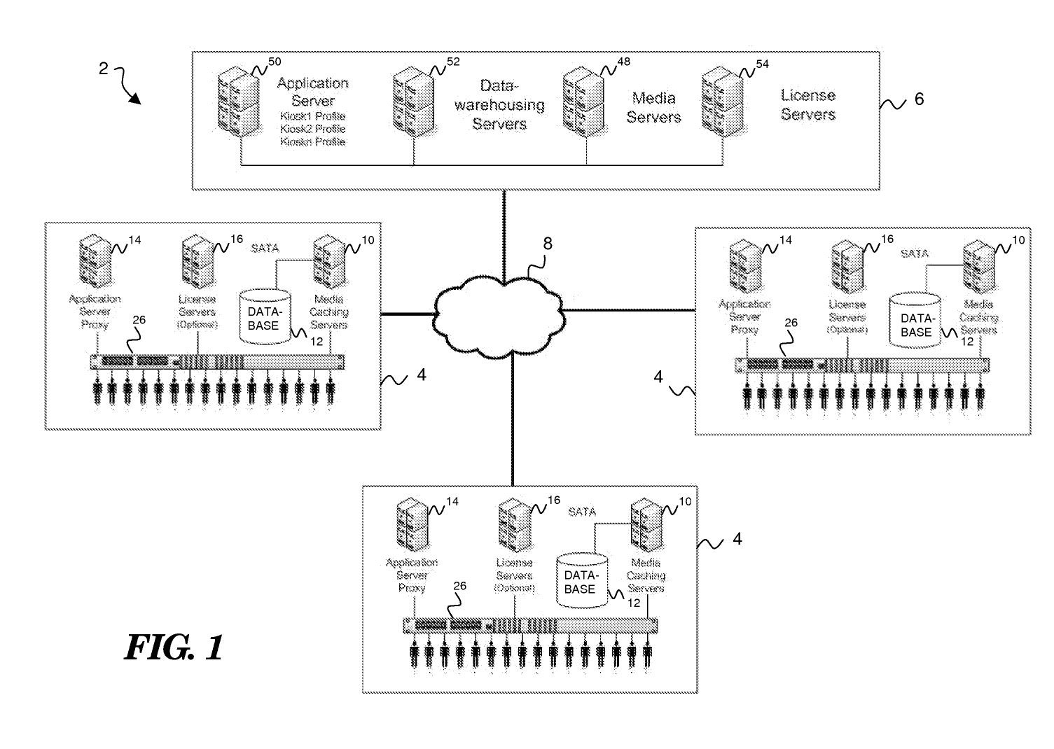

Turning now to the drawings, wherein like reference numerals indicate like elements in all of the several views, FIG. 1 illustrates an exemplary point-of-sale system 2 for electronic sell-through of multimedia content. The system 2 comprises one or more geographically distributed kiosks 4 and may also include a remote main server farm 6 that communicates with the kiosks, as by a wide area network 8.

As described in more detail below, the kiosks 4 are customer access points adapted for customer selection and transfer of multimedia content to customer devices (not shown). They can be located at convenient locations such as airports, train stations, or other public places. The kiosks 4 may be implemented so as to have a physical point-of-presence that is discernable to customers (physical kiosks) or as virtual kiosks that customers interact with solely by way of screen images appearing on customer devices. Physical kiosks may have any desired size, shape or configuration that is sufficient to facilitate public customer access. Exemplary configurations include automated teller machine designs, vending machine designs, booth designs, cubicle designs, stall designs, stand designs, pavilion designs, counter designs, store front designs, and many more. They may be operated with or without a sales attendant. In a virtual kiosk, wireless (or wireline) communication is established with a customer device and one or more kiosk screen images are generated in the device display. For example, a web browser in the customer device could access a kiosk web page using an advertised URL address. No customer-discernable physical kiosk manifestation is required in this case.

As additionally described in more detail below, the main server farm 6 oversees kiosk operations and sources multimedia content thereto. This component is optional in the point-of-sale system 2 because the kiosks 4 could be operated as stand-alone entities if desired. However, the main server farm 6 facilitates centralized control and management of the kiosks 4 and its use is therefore preferred. For example, the main server farm 6 allows new multimedia content to be easily downloaded to the kiosks 4 via the network 8 as such content becomes available for release. Financial transaction processing is also conveniently handled by the main server farm 6.

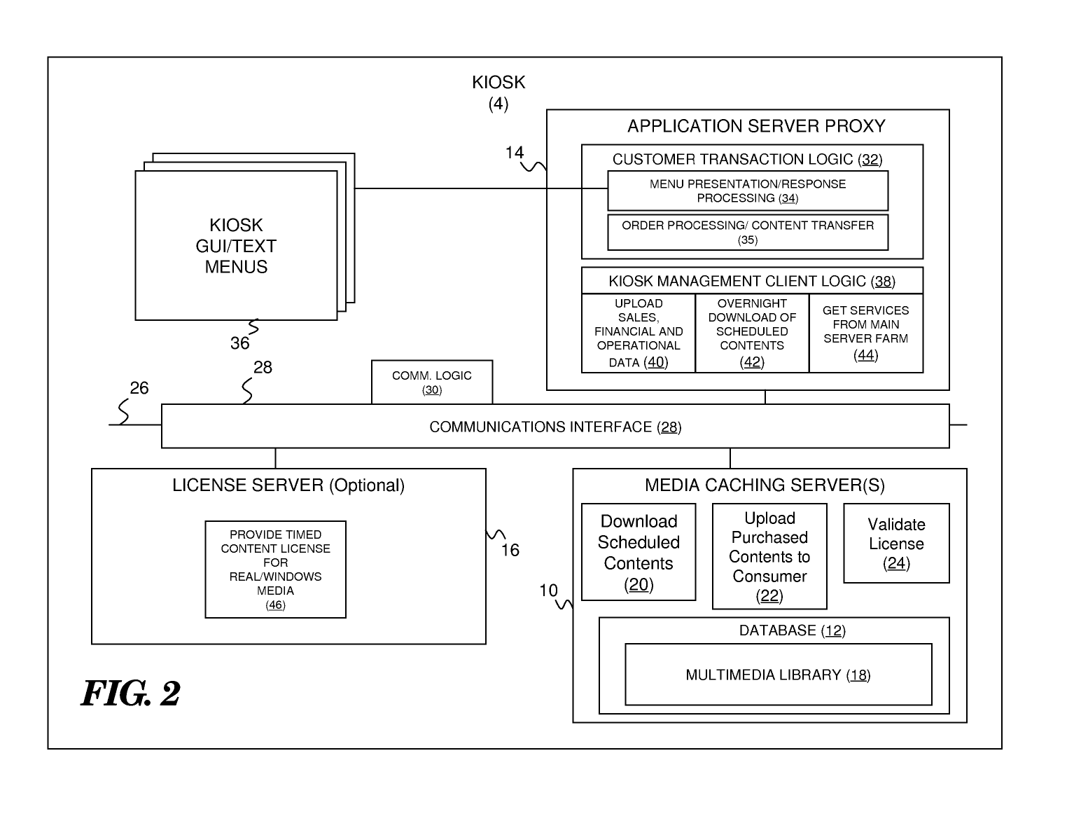

With additional reference now to FIG. 2, each kiosk 4 may include server logic that implements the various kiosk functions to be performed. This server logic may be provided by physically separate server machines or devices, or by way of a single machine or device running plural server instances (e.g., as software supported by a multitasking operating system or by plural operating systems running in virtual machine environments). The kiosk server logic may include a media caching server 10 managing an associated database 12, an application server proxy 14 and an optional license server 16.

The media caching server 10 caches a local multimedia library 18 containing multimedia content in machine-readable form. Exemplary multimedia materials include movies, television programs, sporting events, music, games, etc. The local multimedia content can be stored in any suitable fashion, including on magnetic disk drives (e.g., SATA-attached drives) or on transferable media such as optical disks or magnetic tape cartridges in association with a library picker system for media selection and data acquisition. The multimedia library 18 is accessible via the database 12, which provides sort-query logic for searching and selecting the library content. The media caching server 10 also implements content-downloading logic 20 adapted to download media content from the main server farm 6, content-uploading logic 22 adapted to upload purchased media content to customers, and license validation logic 24 adapted to validate customer-purchased licenses. As an alternative to locally caching multimedia content at each kiosk 4, a global multimedia library (see below) maintained in the main server farm 6 could be used to directly satisfy content upload requests from customers.

A local area network (LAN) 26 may be implemented at each kiosk 4. If the media caching server 10, the application server proxy 14 and the license server 16 are provided by separate machines or devices, the LAN 26 can be used to interconnect them. The LAN 26 also facilitates electronic communication between the kiosk and a customer device, such as a laptop or personal computer, a portable media storage and playback device (e.g., an IPOD® device), a gaming machine, a cellular telephone, etc. LAN interconnectivity may be provided by a network hub, switch, router, or other kiosk communication interface 28. The communication interface 28 could include conventional (e.g., RJ-45) network plug-in jacks so that customer devices can connect to the LAN via conventional (e.g. CAT 5) network cables or the like. Alternatively, the communication interface 28 could provide wireless LAN support so that customer devices can communicate with the kiosks 4 by way of air interfaces. Conventional network communication logic 30 in the communication interface 28 may be used to establish communication between the kiosk 4 and the customer devices. The communication logic 30 is responsible for assigning dynamic IP addresses to the customer devices as they connect to the kiosk, and other low-level network functions. Customer device communication could also be implemented using a USB or Firewire hub for directly attaching the customer devices to the application server proxy 14 or other kiosk computer. Other methods of customer device communication, whether wired or wireless, could no doubt also be used.

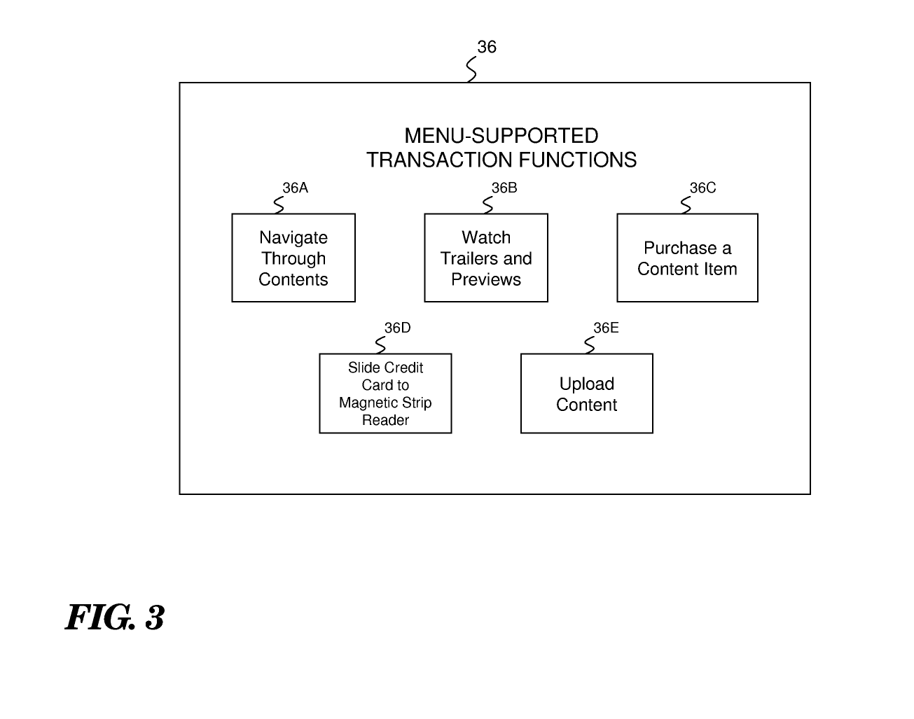

The application server proxy 14 in each kiosk 4 acts as a proxy for an application server (see below) in the main server farm 6. The application server proxy 14 is programmed with customer transaction logic 32 that supports customer selection of multimedia content in the multimedia library 18, and transfer thereof to customer devices via the communication interface 28. The customer transaction logic 32 implements a menu presentation/response processing function 34 that uses one or more kiosk menus 36 and associated programming for processing customer menu selections. The customer transaction logic 32 also implements an order processing and entertainment content transfer function 35 for processing multimedia content purchases and facilitating content uploads to customer devices. The menus 36 generated by the customer transaction logic 24 can be implemented using any suitable menu technology, including web-based solutions (e.g., web page menus), device specific solutions (e.g., IPOD® device menus), etc. For example, if a web-based solution is used, the customer transaction logic 32 could be implemented using a web server operating in conjunction with one or more CGI (common gateway interface) programs that collectively provide the menu presentation/response processing function 34 (and other functions) of the customer transaction logic. The menus 36 may be graphical, text-based, or a combination of both. FIG. 3 illustrates several exemplary transaction functions that may be presented via the menus 36 in order to support kiosk interaction with a customer. A first menu selection 36A may be provided to allow a customer to navigate the contents of the multimedia library 18. A second menu selection 36B may be provided to allow a customer to sample the contents of the multimedia library 18, such as by watching movie trailers or previews. A third menu selection 36C may be provided to allow a customer to navigate purchase a multimedia content item. A fourth menu selection 36D may be provided to allow a customer to pay for the selected multimedia content using a credit or debit card. A fifth menu selection 36E may be provided to allow a customer to upload the multimedia content after it has been purchased. The application server proxy 14 may further include kiosk management client logic 38 that provides three functions 44, 42 and 44 that are respectively responsible for periodically downloading multimedia content from the main server farm 6 (function 40), periodically uploading sales, financial and operational data to the main server farm 6 (function 42), and optionally obtaining other services from the main server farm (function 44).

The license server 16 within each kiosk 4 implements logic 46 for providing timed content licenses and performing other digital rights management (DRM) functions relative to multimedia content selected by customers. Alternatively, licensing control functions may be implemented at the main server farm 6.

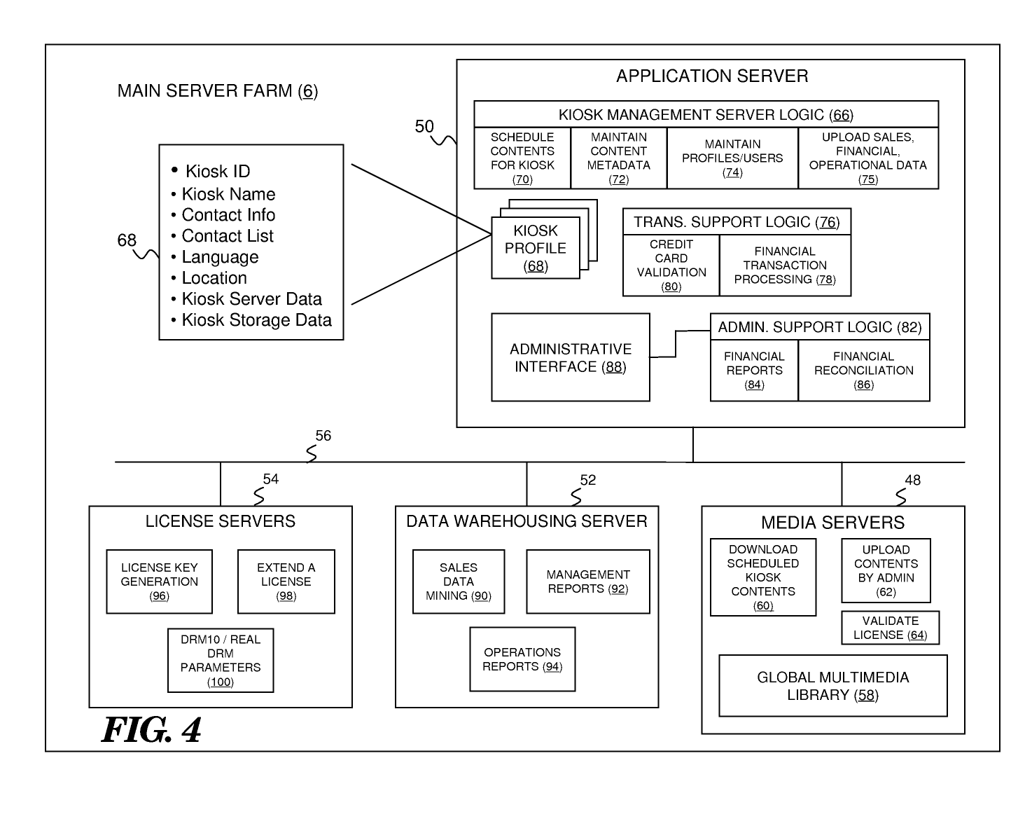

With additional reference now to FIG. 4, the main server farm 6 communicates with each kiosk 4 in order to implement desired kiosk management functions and to supply the kiosks with multimedia content. The main server farm 6 comprises server logic that implements the various server functions to be performed. This server logic may be provided by separate physical server machines or devices, or by way of a single machine or device running plural server instances (e.g., as software supported by a multitasking operating system or by plural operating systems running in virtual machine environments). The server logic implemented by the server farm 6 may include one or more media servers 48, an application server 50, a data warehousing server 52, and one or more license servers 54. If the server logic is provided by separate machines or devices, a LAN 56 may be used to interconnect them.

The media servers 48 in the main server farm 6 are responsible for maintaining a global multimedia library 50 that contains multimedia content in machine-readable form for distribution to the kiosks 4. The global multimedia library 58 stores a superset of the multimedia library 18 maintained at each kiosk 4. The content of the global multimedia library 58 can be stored in any suitable fashion, including on magnetic disk drives or on transferable media such as optical disks or magnetic tape cartridges in association with a library picker system for media selection and data acquisition. The media servers 48 also implement content downloading logic 60 that facilitates the downloading of scheduled multimedia content to the kiosks, content uploading logic 62 that facilitates the receipt new media content uploaded by an administrator, and license validation logic 64 that facilitates license validation of multimedia content.

The application server 50 in the main server farm 6 is programmed with kiosk management server logic 66 that supports kiosk management operations. The kiosk management server logic 66 maintains a set of kiosk profiles 68, each of which corresponds to a particular kiosk 4. Exemplary information that may be stored in a kiosk profile 68 includes (1) a kiosk identification number, (2) a kiosk name, (3) kiosk contact information or a kiosk contact list that specifies kiosk administrative contact information, (4) language and location data that can be used to select appropriate multimedia content to be downloaded to the kiosk, and 5) kiosk server data that specifies information about kiosk server operations, and (6) kiosk storage data that specifies information about the multimedia content maintained at the kiosk. The kiosk management server logic 66 is also responsible for managing the periodic downloading of multimedia content to the kiosks 4 and the periodic uploading of sales, financial and operational data from the kiosks. Functions associated with content downloading include scheduling multimedia content for each kiosk 4 (reference numeral 70), maintaining multimedia content metadata and digital certificates (reference numeral 72), and maintaining kiosk user profiles (reference numeral 74). A function 75 manages the uploading of sales, financial and operational data from the kiosks 4. The application server 50 is further programmed with kiosk transaction support logic 76 whose functions include financial transaction processing (reference numeral 78) and credit card validation to support customer acquisition of multimedia content at the kiosks 4 (reference numeral 80). The application server 50 is also programmed with server administrative support logic 82 whose functions include financial report generation (reference numeral 84) and financial reconciliation (reference numeral 86). An administrative interface 88 facilitates administrative access to the main server farm 6. An administrator will use the administrative interface 88 to maintain the system's global multimedia content, manage licenses, and obtain financial, operations and management report information.

The data warehousing server 52 in the main server farm 6 may be used to perform sales data mining and to generate management and operations reports. The data warehousing server 52 thus implements sales data mining logic 90, management report generating logic 92 and operations report generating logic 94 that respectively operates on the sales, financial and operational data received from the kiosks 4.

The license servers 54 in the main server farm 6 may be used to implement global license control logic on behalf of the kiosks 4. This global license control includes providing timed content licenses and performing other digital rights management (DRM) functions relative to multimedia content selected by customers. In particular, license key generation logic 96 is implemented in order to generate license keys for use by the kiosks 4, license key extension logic 98 is implemented when it is desired to extend the life of an existing license, and digital rights management logic 100 is implemented to process digital rights management parameters.

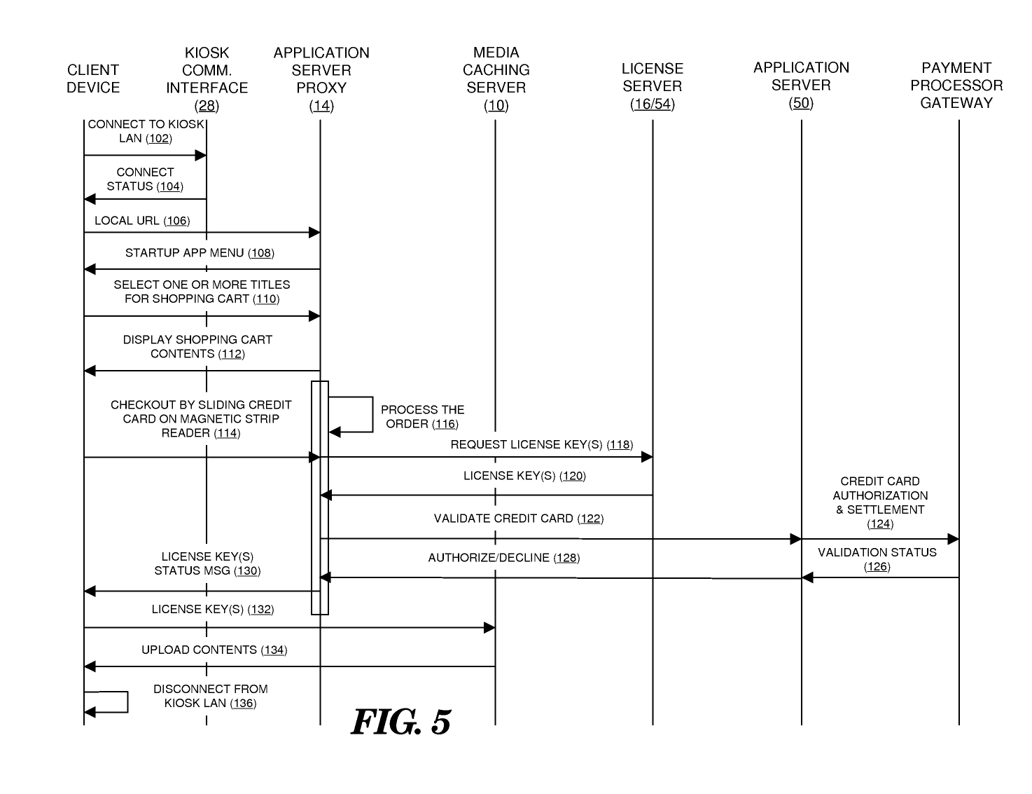

Turning now to FIG. 5, an exemplary transaction sequence is shown whereby a customer accesses a kiosk 4 and acquires multimedia content. The sequence begins with a customer device connecting to the kiosk 4, accessing the kiosk application server proxy 14, and receiving an initial startup menu 36. In an exemplary implementation of the point-of-sale system 2, the connection process includes a first step 102 in which the customer device requests connection to via the communications interface 28 to the kiosk LAN 26, and a second step 104 in which the communication interface returns connection status information to the customer device (e.g., an assigned IP number, etc.). In step 106, the customer device access the application server proxy 14, for example, by presenting a local URL address if the application server proxy implements a web-based interface. In that case, the customer device could utilize web browser logic to issue the URL request. In step 108, the menu presentation/response function 34 of the application server proxy's customer transaction logic 32 returns the initial startup menu 36, which could be the menu shown in FIG. 3.

Using the menus 36 (e.g. menu selections 36A, 36B and 36C), the customer makes one or more multimedia selections, as shown in step 110. Search functions provided by the database 12 in the media caching server(s) 10 are available to assist the customer browse for and preview multimedia content using menu selections 36A and 36B. In step 112, which follows the customer's activation of menu selection 36C, the customer transaction logic 32 in the application server proxy 14 verifies the selections to the customer device using a shopping cart mechanism or other online purchasing paradigm. In step 114, the customer approves the content selections and is prompted by a menu 36 (e.g. menu selection 36D) to slide a financial transaction card through a magnetic strip reader that may be associated with the kiosk (e.g., if the kiosk is a physical kiosk), or to enter a credit card number (e.g., if the kiosk is a virtual kiosk). Order processing is then performed by the order processing/content transfer function 35 of the customer transaction logic 32 in step 116. Based on the customer's selections, the customer transaction logic 32 requests (step 118) one or more license keys from the kiosk license server 16, if one is present. Otherwise, licenses are requested from the license server 54 in the main server farm 6. If the license server 16 is accessed, its logic 46 provides one or more timed content license keys in step 120. If the license server 54 is invoked, its logic 96 generates a license key or its logic 98 extends an existing license. The logic 100 may also be invoked in the license server 54 to generate digital rights management parameters that are associated with the returned license key(s). The content license key(s) and digital rights management parameters (if any) are returned to the application server proxy 14 in step 120. The application server proxy 14 then forwards the customer's credit card information in step 122 to the application server 50 in the main server farm 6. The transaction support logic 76 in the application server 50 takes responsive action. In step 124, its financial transaction processing function 78 processes the incoming credit card information and its credit card validation function 80 accesses a payment processor gateway (not shown) implemented by the card-issuing financial institution. In step 126, a validation status is returned to the credit card validation function 80 and in step 128 the financial transaction processing function 78 processes the validation information and returns an authorize/decline response to the application server proxy 14. If the transaction is authorized, the application server proxy 14 returns the associated license key(s) and a status message to the customer device in step 130. Again, the foregoing operations of the application server proxy 14 are performed by the order processing/content transfer function 35 of the customer transaction logic 32. Using the menu 36 (e.g., menu selection 36E), the customer initiates the multimedia content uploading process and the order processing/content transfer function 35 of the customer transaction logic 32 responds by directing the customer device (or by forwarding the upload request) to one of the media caching servers 10 for content uploading. In step 132, the customer device presents the license key(s) to the media caching server 10. The license validation logic 24 therein validates the license key(s) and the content uploading logic 22 retrieves the corresponding multimedia content from the multimedia library 18 and uploads it to the customer device in step 134. The customer device may then disconnect from the kiosk LAN in step 136.

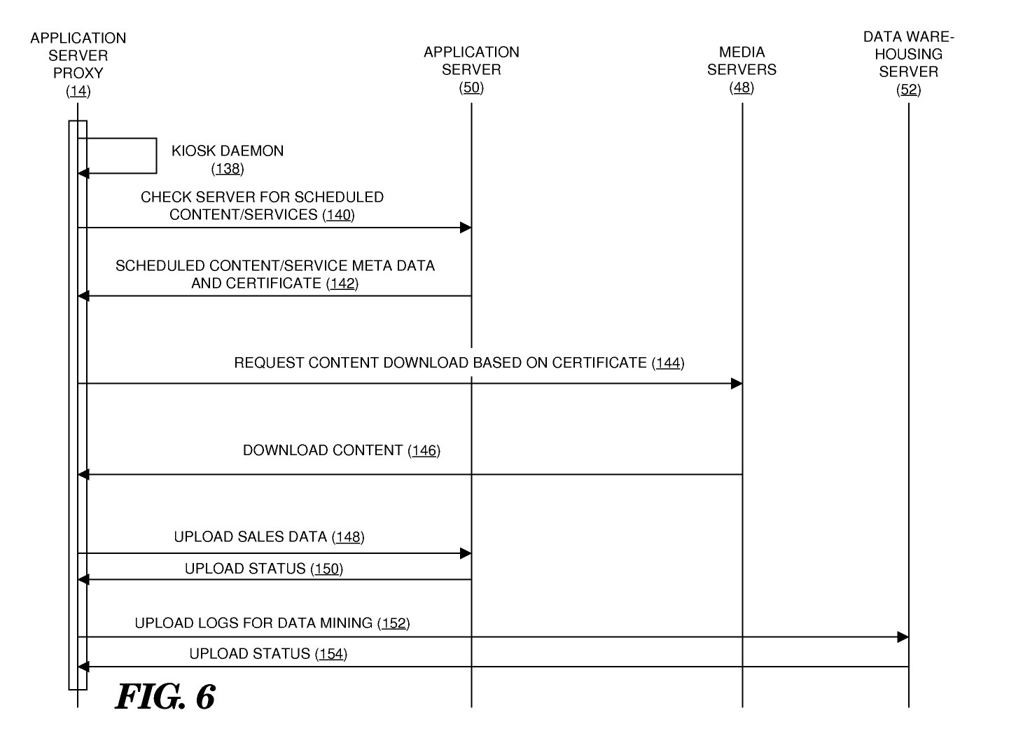

Turning now to FIG. 6, an exemplary kiosk management sequence is shown whereby a kiosk 4 downloads multimedia content from the main server farm 6, and whereby the kiosk uploads sales and operational data. The sequence begins with the kiosk management client logic 38, implemented as a daemon process or the like in the kiosk application server proxy 14, being scheduled to run periodically, such as once per night, once per week, etc. Step 138 in FIG. 6 represents this periodic processing. When the scheduled time arrives, the kiosk management client logic 38 checks with the application server 50 in the main server farm 6 to see if new multimedia content has been scheduled for download to the kiosk 4. If so, the application server 50 downloads metadata for the new content to the application proxy server 14, together with a digital certificate. These actions are respectively shown by steps 140 and 142 in FIG. 6. On the application proxy server side, the content downloading function 42 is responsible for performing the described actions. On the application server side, the kiosk management server logic 66, and particularly its functions 70, 72 and 74, implement the actions of steps 140 and 142. In particular, the content scheduling function 70 schedules new multimedia content for the kiosk 4 based on metadata representing the kiosk's current content, which is tracked by the content metadata maintenance function 72. Selection of the new content is also assisted by the kiosk profile maintenance function 74, which maintains the kiosk profiles 68 that specify demographics information such as kiosk language and location. Although not shown in FIG. 6, service updates for the kiosk 4 could be requested periodically from the application server 50 by the application server proxy 14. The get-services function 44 of the kiosk management client logic 38 can be used to implement this action. The service updates allow the kiosk 4 to be upgraded with new software or firmware logic (e.g., in order to enhance kiosk operations).

In step 144, the kiosk management client logic 38 invokes the logic 20 in the media caching server(s) 10 to present the content metadata and digital certificate to the media servers 48 in the main server farm 6. The media server content downloading logic 60 processes the request by invoking the license validation logic 64 to perform license validation as a check to ensure that the requested multimedia content (based on the content metadata) is validly licensed for download. The content downloading logic 60 then retrieves the requested content from the global multimedia library 58 and downloads it in step 146 to the media caching server's content downloading logic 20, which places the new content in the multimedia library 18.

The application server proxy 14 may upload sales data to the application server 50 in the main server farm 6, receiving upload status indicators in response. These actions are shown by steps 148 and 150 in FIG. 6. Steps 148 and 150 are implemented on the application server proxy side by the data uploading function 40 of the kiosk management client logic 38. On the application server side, the sales, financial, operational data upload function 75 is involved in steps 148 and 150. Although not shown in FIG. 6, the function 75 may forward the sales data to the data warehousing server 52 for handling by the sales data mining logic 90. The application server proxy 14 may also upload transaction log data for data mining purposes to the data warehousing server 52, receiving upload status indicators in response. These actions are shown by steps 152 and 154 in FIG. 6. Steps 152 and 154 are implemented on the application server proxy side by the data uploading function 40 of the kiosk management client logic 38. On the application server side, the sales, financial, operational data upload function 75 receives the request as part of step 152 and forwards it to the sales data mining logic 90 of the data warehousing server 52. During step 154, the sales, financial, operational data upload function 75 receives upload status indicators from the sales data mining logic 90 and forwards them to the application server proxy 14.

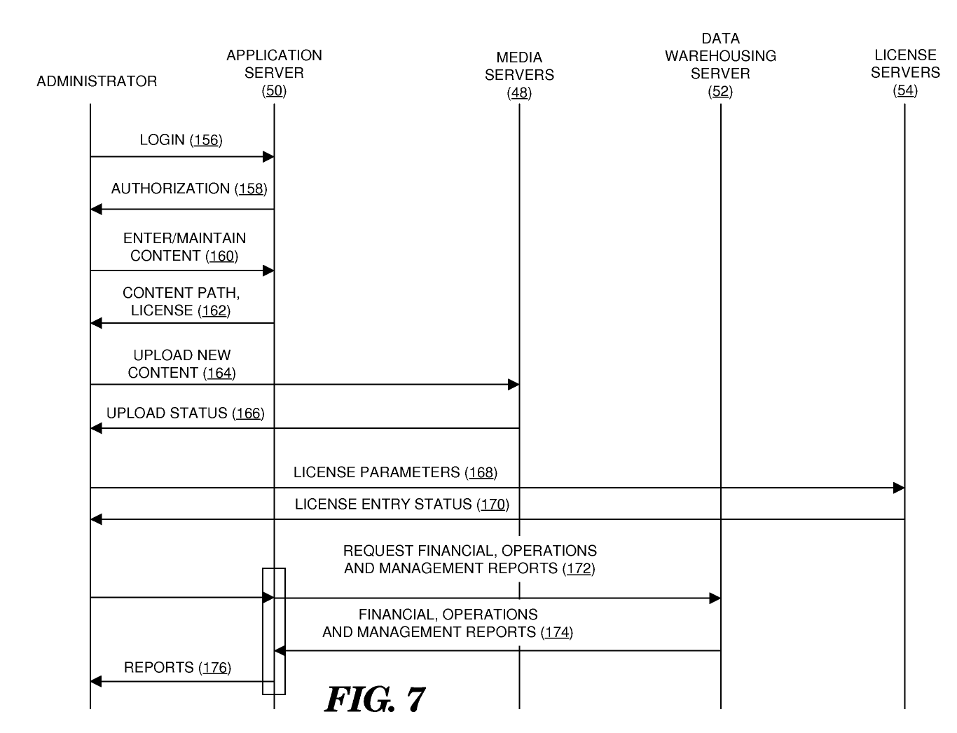

Turning now to FIG. 7, an exemplary administrative sequence is shown whereby an administrator manages the main server farm 6. The sequence begins with administrator login and authorization at the application server's administrative interface 88 in steps 156 and 158. Thereafter, in step 160, the administrator advises that he/she wishes to enter new multimedia content and/or maintain old content (e.g., updating, deleting, etc.). In step 162, the administrative support logic 82 provides a content path of the media server(s) 48 where the multimedia content may be stored. License parameters are also provided for the administrator to present to the license server(s) 54. In step 164, the administrator uploads new multimedia content to the media server(s) 48 and an upload status indicator is returned by the latter's content upload logic 62 in step 166. In step 168, the administrator uploads the licensing information for the new multimedia content to one of the license servers 54 and the latter returns a license entry status indicator in step 170. In step 172, the administrator queries the application server 50 for financial, operations and management reports. The financial reports function 84 and the financial reconciliation function 86 of the administrative support logic 82 process the request for financial reports. Operations and management reports are prepared by the data warehousing server 52. The sales data mining logic 90, the management reports logic 92, and the operations report logic 94 are invoked as necessary to generate the requested reports. In step 174, the application server 50 retrieves the operations and management reports from the data warehousing server 52 and returns the requested report information to the administrator in step 176.

Accordingly, a point-of-sale system for electronic sell-through of multimedia content has been disclosed. It should, of course, be understood that the description and the drawings herein are merely illustrative, and it will be apparent that various modifications, combinations and changes can be made in accordance with the invention. For example, instead of transferring multimedia content electronically to a customer device, it would also be possible, using automated means, to record the multimedia content on a medium, such as an optical disk, a memory storage device, etc., and then transfer the medium to the customer (as by ejecting the medium from the kiosk) for use with the customer device. As such, the invention is not to be in any way limited except in accordance with the spirit of the appended claims and their equivalents.

What is claimed is:

1. A point-of-sale system for electronic sell-through of multimedia content, comprising:
a kiosk for customer selection and transfer of multimedia content to a customer device;
a local multimedia library associated with said kiosk containing multimedia content in machine-readable form;
a customer communication interface associated with said kiosk adapted to facilitate electronic communication between said kiosk and a customer device; and
customer transaction logic associated with said kiosk adapted to facilitate customer selection of multimedia content in said multimedia library and transfer of said selected content to said customer device via said communication interface.

2. A system in accordance with claim 1, wherein said kiosk comprises one of a physical kiosk or a virtual kiosk.

3. A system in accordance with claim 1, wherein said customer communication interface comprises one of a wireline device or a wireless device.

4. A system in accordance with claim 1, wherein said kiosk comprises plural kiosk servers and said customer communication logic provides local area network connectivity for interconnecting said kiosk servers.

5. A system in accordance with claim 1, wherein said customer transaction logic comprises a web-based menu presentation and response processing function, an order processing function, and a multimedia content transfer function.

6. A system in accordance with claim 1 wherein said system further comprises kiosk management client logic adapted to communicate with a remote server system to periodically download multimedia content from said remote server, and to periodically upload sales, financial or operational data to said remote server.

7. A system in accordance with claim 1, wherein said system further comprises kiosk licensing logic adapted to implement a kiosk license control function.

8. A point-of-sale system for electronic sell-through of multimedia content, comprising:
a main server system adapted to communicate with plural kiosks that each comprise a local multimedia library containing multimedia content in machine-readable form for local access by customers; and
said main server being adapted to oversee kiosk operations and update said local multimedia libraries.

9. A system in accordance with claim 8, wherein said remote server system comprises a global multimedia library containing multimedia content in machine-readable form representing a superset of multimedia content in said local multimedia library of each of said kiosks.

10. A system in accordance with claim 9, wherein said remote server system comprises kiosk management server logic adapted to maintain one or more kiosk profiles that determine what multimedia content is available to said local multimedia library of each of said kiosks, to manage the download of multimedia content to said kiosks, and to manage the upload of sales, financial or operational data from said kiosks.

11. A system in accordance with claim 10, wherein said remote server system further includes kiosk transaction support logic adapted to support customer acquisition of multimedia content at said kiosks.

12. A system in accordance with claim 11, wherein said remote server system comprises server license control logic adapted to implement a global license control function for licensing multimedia content accessed at said kiosks.

13. A system in accordance with claim 12, wherein said remote server system comprises data warehousing logic adapted to process sales, financial or operational data received from said kiosks.

14. A system in accordance with claim 13, wherein said remote server system comprises administrative support logic adapted to facilitate administrative access to said remote server system for multimedia content management, license management and obtaining financial, operations or management information.

15. A point-of-sale system for electronic sell-through of multimedia content, comprising:
plural kiosks, each of said kiosks comprising:
a local multimedia library containing multimedia content in machine-readable form;
a customer communication interface adapted to facilitate electronic communication between said kiosk and a customer device;
customer transaction logic adapted to facilitate customer selection of multimedia content in said multimedia library and transfer of said selected content to said customer device via said communication interface; and
a main server system adapted to communicate with said kiosks in order to oversee kiosk operations and update said local multimedia libraries.

16. A point-of-sale system for electronic sell-through of multimedia content, comprising:
a kiosk having access to a multimedia library containing multimedia content in machine-readable form; and
customer transaction logic adapted to facilitate customer selection of multimedia content in said multimedia library and automated transfer of said selected content to a customer.

17. A point-of-sale system in accordance with claim 16 wherein said multimedia library is local to said kiosk.

18. A point-of-sale system in accordance with claim 16 wherein said multimedia library is associated with a remote server system.

19. A point-of-sale method for electronic sell-through of multimedia content, comprising:
providing a kiosk having access to a multimedia library containing multimedia content in machine-readable form; and
allowing a customer to interact with said kiosk so as to facilitate customer selection of multimedia content in said multimedia library and automated transfer of said selected content to said customer.

20. A point-of-sale method in accordance with claim 19 wherein said multimedia library is local to said kiosk.

21. A point-of-sale system in accordance with claim 19 wherein said multimedia library is associated with a remote server system.
